(19) United States
(12) Patent Application Publication
(10) Pub. No.: US 2013/0070906 A1
(43) Pub. Date: Mar. 21, 2013

(54) X-RAY IMAGING APPARATUS

(71) Applicants: Hidetomo Suwa, Machida-shi (JP); Tetsuo Watanabe, Utsunomiya-shi (JP)

(72) Inventors: Hidetomo Suwa, Machida-shi (JP); Tetsuo Watanabe, Utsunomiya-shi (JP)

(73) Assignee: CANON KABUSHIKI KAISHA, Tokyo (JP)

(21) Appl. No.: 13/609,883

(22) Filed: Sep. 11, 2012

(30) Foreign Application Priority Data
Sep. 15, 2011 (JP) 2011-201865
Nov. 14, 2011 (JP) 2011-248822

(51) Int. Cl. G03B 42/02

(52) U.S. Cl. 378/177

(57) ABSTRACT

An X-ray imaging apparatus includes a storage unit configured to store a portable X-ray imaging apparatus including an X-ray plane detection unit and a carrying handle unit, and a positioning member configured to position a photographing center of the storage unit and a photographing center of the portable X-ray imaging apparatus by deviating a position of the portable X-ray imaging apparatus stored in the storage unit by an offset of the handle unit.

### BACKGROUND OF THE INVENTION

1. Field of the invention

The present invention relates to a portable X-ray imaging apparatus.

2. Description of the Related Art

X-ray imaging systems configured to photograph an X-ray image using a semiconductor sensor has been developed with the recent rise of a semiconductor process technique. These systems have a very wide dynamic range as compared with an X-ray photographing system using a conventional photographic film.

Therefore, the systems have an advantage of obtaining an X-ray image which is not influenced by the variation of an exposure amount of X rays. Furthermore, because chemical treating is not required for the systems unlike a conventional photographic film method, the systems have an advantage of instantaneously obtaining an output image.

FIG. 1 illustrates a schematic diagram of a general X-ray imaging system using such an X-ray imaging apparatus. An X-ray imaging apparatus 1 includes a reading unit 2 configured to detect X-ray distribution transmitted through a subject and two-dimensionally arranged. An X-ray generator 3 is provided above the X-ray imaging apparatus 1. X rays are radiated to a subject 6 from the X-ray generator 3.

The X rays transmitted through the subject 6 are converted into visible light via a fluorescent material. The visible light is radiated to a photoelectric transfer element arranged in a two-dimensional lattice state, and is detected as an electric signal.

The X-ray imaging apparatus 1 includes a control unit configured to perform control such as read-out driving or image transfer. An image output from the X-ray imaging apparatus 1 is subjected to digital image processing in an image processing unit 4. The X-ray image of the subject 6 is displayed on a monitor 5. The system has an advantage of instantaneously displaying an image on the monitor unlike the X-ray image recording-reproducing system configured to read the image in post-processing.

In recent years, a portable X-ray imaging apparatus has spread. The use of the portable X-ray imaging apparatus has been increased in photographing in an optional photographing attitude and a round application.

Recently, a portable photographing apparatus having a handle function has been proposed as discussed in Japanese Patent Application Laid-Open No. 2009-237074. In Japanese Patent Application Laid-Open No. 2009-237074, the portable photographing apparatus has a detachably-attached handle in a short side direction.

Japanese Patent Application Laid-Open No. 2009-300603 discusses a photographing apparatus having detachably-attached handles on one side surface and the other side surface perpendicular to the side surface.

In recent years, the portable X-ray imaging apparatus has spread. However, many users are accustomed to an operation of a conventional film cassette. Demand for performing the same operation as that of the conventional film cassette in the portable X-ray imaging apparatus is increased.

More specifically, in addition to the utilization of the X-ray imaging apparatus in the photographing in the optional attitude and the round application which are previously described, the operation of the X-ray imaging apparatus in a state where the X-ray imaging apparatus is stored in an erect position stand and a decubitus table stand is increasingly demanded.

However, due to limitations of the shape of a handle unit, the X-ray imaging apparatus having the handle cannot be stored in the existing erect position stand or decubitus table stand. Even if the X-ray imaging apparatus having the handle can be stored in the existing film cassette stand, it is difficult to adjust the center position of an image effective area of a reading unit in the X-ray imaging apparatus 1 to the positioning center of the stand.

The apparatus discussed in the above-mentioned Japanese Patent Application Laid-Open No. 2009-237074 has the handle on the short side thereof. When the photographing apparatus supports a half cut size, the handle unit becomes obstructive in the case where the photographing apparatus is stored in the existing film cassette stand, and the photographing apparatus cannot be stored. Although the handle has a detachably-attached structure, the handle is screw-fixed, which complicates attachment and detachment of the handle by a user. Even if the handle can be easily attached and detached, it is necessary to manage the handle itself, that is, to reserve a place for storing the detached handle, which impairs convenience.

The apparatus discussed in Japanese Patent Application Laid-Open No. 2009-300603 also has a detachably-attached handle. However, in the X-ray imaging apparatus supporting a half cut size, the X-ray imaging apparatus does not have such a shape that enables the X-ray imaging apparatus to be stored in the existing film cassette stand with the handle attached.

Even if the handle can be easily attached and detached as in Japanese Patent Application Laid-Open No. 2009-237074, it is necessary to manage the detached handle itself, which impairs convenience. Furthermore, it is necessary to provide an attaching/detaching mechanism to attach and detach the handle unit. To improve the convenience of attachment and detachment operations, the structure of the attaching/detaching mechanism becomes complex, and requires an increasing number of components, which cause a cost increase. Furthermore, the apparatus becomes heavy, which impairs portability.

### SUMMARY OF THE INVENTION

The present invention is directed to an X-ray imaging apparatus including a handle unit with improved convenience when the X-ray imaging apparatus is stored in a cassette stand.

According to an aspect of the present invention, an X-ray imaging apparatus includes a storage unit configured to store a portable X-ray imaging apparatus including an X-ray plane detection unit and a carrying handle unit, and a positioning member configured to position a photographing center of the storage unit and a photographing center of the portable X-ray imaging apparatus by deviating a position of the portable X-ray imaging apparatus stored in the storage unit by an offset of the handle unit.

Further features and aspects of the present invention will become apparent 0from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a use condition of an X-ray imaging apparatus.

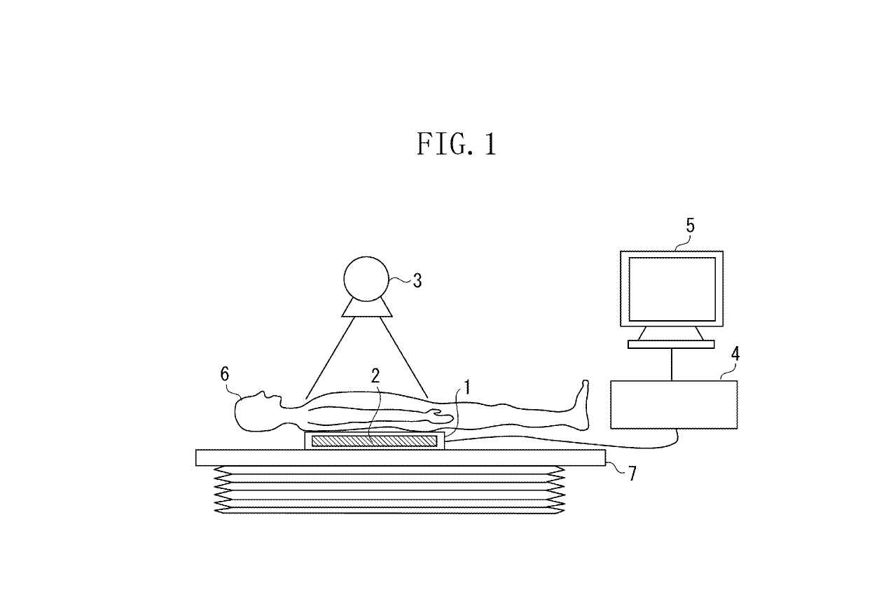

FIGS. 2A and 2B illustrate a constitution of an X-ray imaging apparatus in a first exemplary embodiment of the present invention.

FIGS. 3A and 3B illustrate a constitution of an X-ray imaging apparatus in a first exemplary embodiment.

FIGS. 4A and 4B illustrate a constitution of an X-ray imaging apparatus in a first exemplary embodiment.

FIGS. 5A and 5B illustrate a constitution of an X-ray imaging apparatus in a second exemplary embodiment of the present invention.

FIG. 6 illustrates a constitution of an X-ray imaging apparatus in a third exemplary embodiment of the present invention.

FIG. 7 illustrates a constitution of an X-ray photographing system in a fourth exemplary embodiment of the present invention.

FIG. 8 illustrates constitutions of various stands.

FIG. 9 illustrates a structure of a grid.

FIG. 10 illustrates a constitution of an X-ray photographing system in a fourth exemplary embodiment of the present invention.

FIG. 11 illustrates a constitution of an X-ray photographing system in a fifth exemplary embodiment of the present invention.

FIG. 12 illustrates a constitution of an X-ray photographing system in a sixth exemplary embodiment of the present invention.

### DESCRIPTION OF THE EMBODIMENTS

Various exemplary embodiments, features, and aspects of the invention will be described in detail below with reference to the drawings.

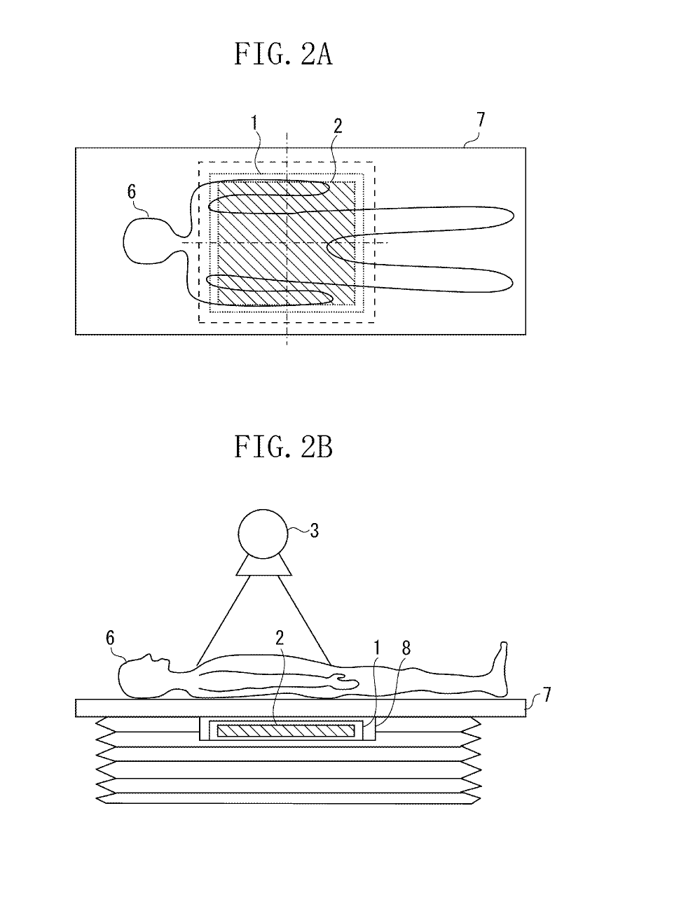

FIGS. 2A and 2B illustrate a portable X-ray imaging apparatus 1 (portable X-ray imaging apparatus) according to a first exemplary embodiment of the present invention, which is attached to a stand 7.

FIG. 2A illustrates the portable X-ray imaging apparatus 1 viewed from an X-ray incident direction. FIG. 2B illustrates the portable X-ray imaging apparatus 1 viewed from a side surface.

As illustrated in FIG. 2, a storage unit 8 for the X-ray imaging apparatus 1 is provided below the stand 7. The storage unit 8 can store the X-ray imaging apparatus 1.

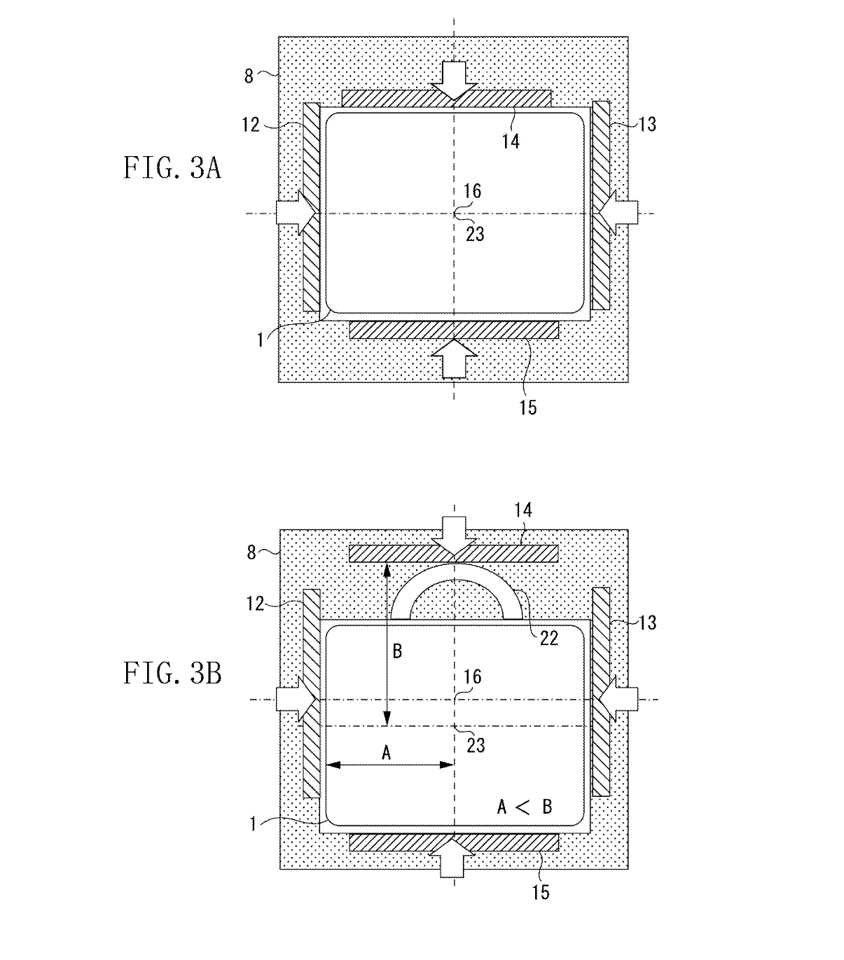

FIG. 3A is a detail view of the storage unit 8 viewed from a direction of FIG. 2A. The storage unit 8 includes movable positioning mechanisms 12, 13, 14, and 15 configured to move the stored X-ray imaging apparatus 1 in the center direction of the storage unit 8.

The positioning mechanisms 12 and 13 are moved interlockingly with each other. The positioning mechanisms 14 and 15 are moved interlockingly with each other. The maximum outer size of the X-ray imaging apparatus 1 includes an image effective area of 14×17 inches, which is the maximum size of a conventional film cassette, and is of a standard size of 384×460 mm.

Because the X-ray imaging apparatus 1 is mounted in a state where the X-ray imaging apparatus 1 is rotated by 90 degrees in some cases, the maximum outer size of the X-ray imaging apparatus 1 that can be stored in the storage unit 8 is about a 460 mm-side square.

When the X-ray imaging apparatus 1 has a symmetric shape such as a rectangle, the positioning mechanisms 12 to 15 are operated, thereby moving the X-ray imaging apparatus 1 to the center direction of the storage unit 8 and fixing the position of the X-ray imaging apparatus 1.

The mechanism can make a center 23 of an image effective area (effective photographing area) of a reading unit of the X-ray imaging apparatus 1 coincide with a positioning center 16 of the storage unit 8.

FIG. 3B is a detail view of a case where the X-ray imaging apparatus 1 including a carrying handle is mounted in the storage unit 8 of the existing film cassette stand. The X-ray imaging apparatus 1 including a handle 22 (handle unit) on a long side has an asymmetric shape. Therefore, even when the same positioning mechanism as that of FIG. 3A is operated, the center 23 of the image effective area of the reading unit of the X-ray imaging apparatus 1 and the positioning center 16 of the storage unit 8 deviate from each other.

When the X-ray imaging apparatus 1 is stored in the storage unit 8, the X-ray imaging apparatus 1 vanishes from a photographing user such as an engineer. Therefore, even if the centers deviate from each other, it is difficult for the user to position an area to be photographed and the X-ray imaging apparatus 1.

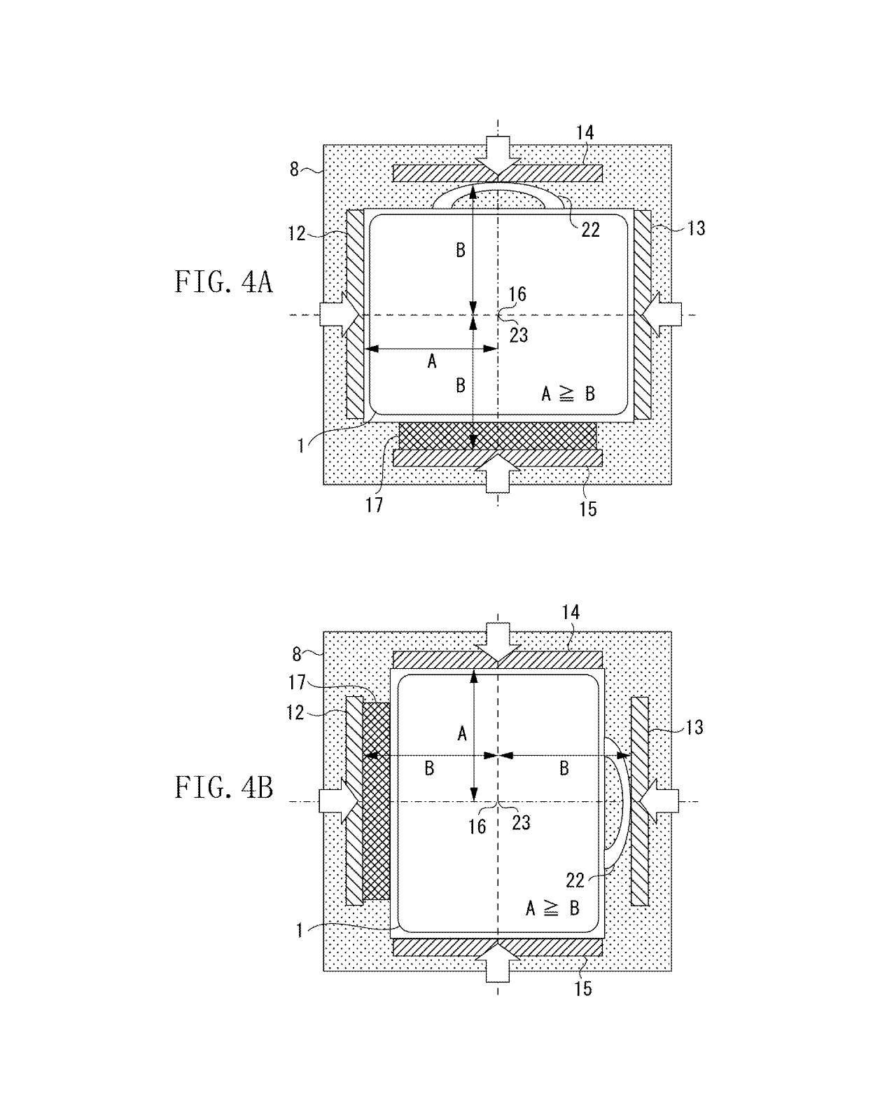

In the X-ray imaging apparatus 1 according to the first exemplary embodiment, as illustrated in FIG. 4A, a relation between a distance A between each of two side surfaces perpendicular to a side surface having the handle 22 and the center 23 of the image effective area of the reading unit and a distance B between the center 23 of the image effective area of the reading unit and the outermost shape of the side surface having the handle 22 is set such that A B. Furthermore, a spacer 17 (positioning member) is disposed on the opposite side of the side surface having the handle 22 so as to have the same distance as the distance B between the center 23 of the image effective area of the reading unit of the X-ray imaging apparatus 1 and the outermost shape of the handle 22. The spacer 17 corrects the offset of the handle 22.

Thus, the X-ray imaging apparatus 1 including the handle 22 can be stored in the existing film cassette stand. The center 23 of the image effective area of the reading unit of the X-ray imaging apparatus 1 can be adjusted to the positioning center 16 of the stand. In the present exemplary embodiment, the offset of the handle 22 is corrected by disposing the spacer 17 (positioning member). However, a position of a holding member configured to hold the X-ray imaging apparatus 1 in the storage unit 8 is adjusted by an adjusting unit (not illustrated), and thereby the offset can be corrected. The adjusting unit may adjust the position of the holding member according to the user's manual operation. The adjusting unit may include a detection sensor configured to detect the position of the handle 22 to automatically adjust the position of the holding member.

The shape can make the center 23 of the image effective area of the reading unit of the X-ray imaging apparatus 1 coincide with the positioning center 16 of the stand even when the X-ray imaging apparatus 1 is stored in a state where the X-ray imaging apparatus 1 is rotated by 90 degrees as illustrated in FIG. 4B.

In this manner, the center 23 of the image effective area of the reading unit of the X-ray imaging apparatus 1 coincides with the positioning center 16 of the stand. Therefore, when the user such as the engineer photographs a subject, the user can appropriately grasp the photographing area, which leads to improvement in usability.

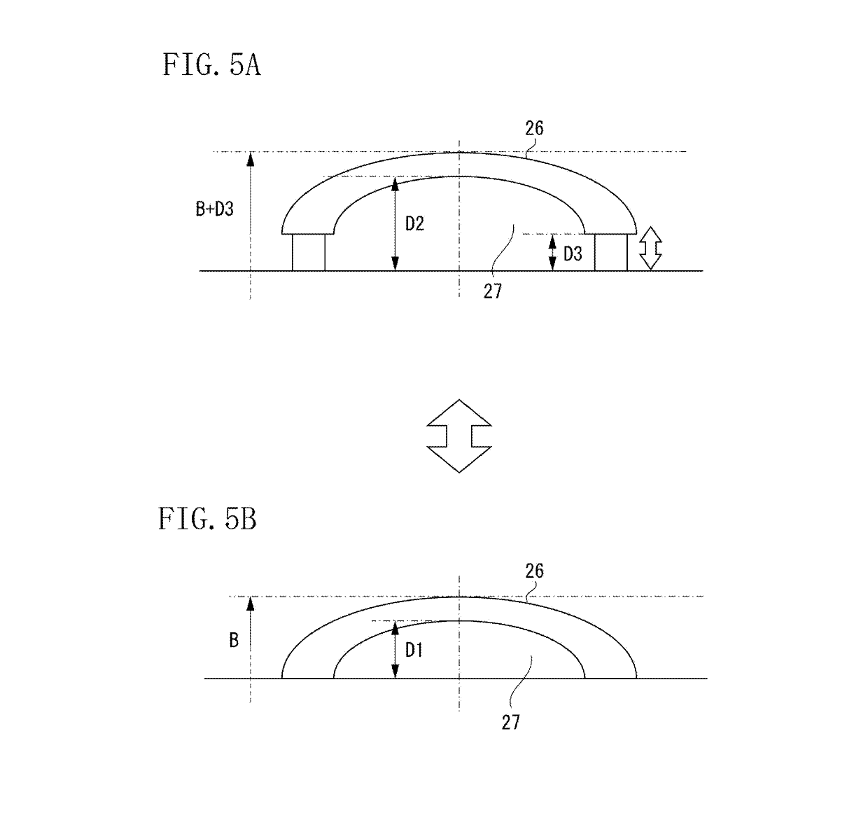

FIGS. 5A and 5B illustrate the enlarged handle 22 of the X-ray imaging apparatus 1. The handle 22 includes a grip unit 26 and an opening portion 27. An operator such as the engineer passes fingers through the opening portion 27 to grasp the grip unit 26 when the operator transports the X-ray imaging apparatus 1.

An opening having a certain level of size is required in order to pass the fingers. However, it is difficult to provide the grip unit 26 and the opening portion 27 within the limitation of B≦230 mm.

In a second exemplary embodiment of the present invention, the handle 22 is a movable. When the X-ray imaging apparatus 1 is transported, the opening portion 27 of the handle 22 is increased by D3 as illustrated in FIG. 5A. The mechanism can sufficiently secure the opening portion 27 and can achieve improvement in portability.

When the X-ray imaging apparatus 1 is stored in the storage unit 8, a part of the handle 22 is stored in the X-ray imaging apparatus 1 as illustrated in FIG. 5B, and the opening portion 27 of the handle 22 becomes small such that A B is satisfied. The mechanism can adjust the center 23 of the image effective area of the reading unit of the X-ray imaging apparatus 1 to the positioning center 16 of the stand by using the spacer 17 even if the X-ray imaging apparatus 1 is stored in the storage unit 8. The mechanism can also improve the portability. In addition, the grip unit 26 can be thickened if needed by employing the movable mechanism as described above, which can further improve the portability.

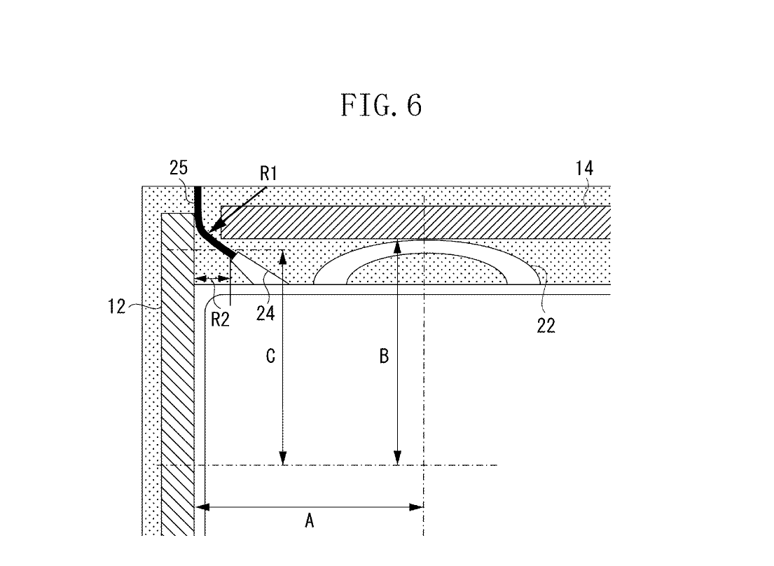

FIG. 6 according to a third exemplary embodiment of the present invention illustrates an example in which a cable 25 is attached to an X-ray imaging apparatus 1.

A cable guide 24 is provided in a connecting unit of the X-ray imaging apparatus 1 and the cable 25. The cable guide 24 has a role to relieve local bending of the cable 25, and is made of an elastic member such as a silicon rubber.

The outlet opening of the cable 25 is on the same side surface as that of a handle 22. A relation between a distance C and a distance B is B>C. The distance C is between the tip of the cable guide 24 and the center 23 of the image effective area of the reading unit of the X-ray imaging apparatus 1. The distance B is between the outermost shape of the handle and the sensor center 23. Thus, the offset of the cable guide 24 is smaller than that of the handle 22. Not the tip of the cable guide 24 but the handle 22 constitutes the outermost shape. The shape prevents the positioning mechanisms 12 to 15 from contacting the cable guide 24 even if the X-ray imaging apparatus 1 is stored in a storage unit 8, and positioning mechanisms 12 to 15 are operated to perform positioning. Therefore, the center 23 of the image effective area of the reading unit of the X-ray imaging apparatus 1 can be adjusted to a positioning center 16 of a stand without having an influence on the positioning of the X-ray imaging apparatus 1.

A distance between the tip of the cable guide 24 and a side surface near the tip of the cable guide 24, of two side surfaces perpendicular to a side surface having the handle 22 is R2. The distance R2 is greater than the permissible minimum bending R1 of a wired cable. Therefore, the X-ray imaging apparatus 1 can be safely stored without applying an excessive bending load to the cable 25 when the X-ray imaging apparatus 1 is stored in the storage unit 8.

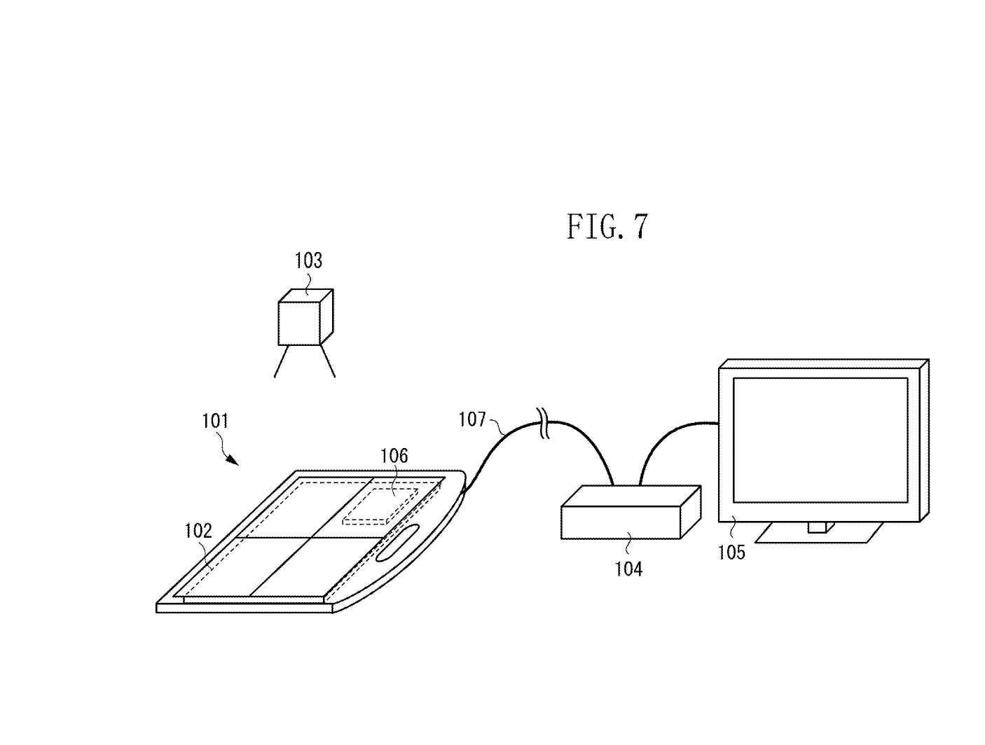

FIG. 7 illustrates a constitution of an X-ray photographing system (X-ray imaging apparatus) according to a fourth exemplary embodiment of the present invention.

An X-ray detection unit 101 includes an X-ray detection sensor 102. The X-ray detection unit 101 includes a photoelectric transfer element configured to detect X rays transmitted through a subject and arranged in a two-dimensional lattice state. The X rays are radiated to the subject by an X-ray generator 103.

A control unit 104 controls image acquisition of the detection unit 101, and is configured to display a photographed image on a monitor 5.

In addition to the X-ray detection sensor 102, the detection unit 101 includes an electric circuit 106 provided on the back side of the X-ray detection sensor 102. The electric circuit 106 controls a photographing operation such as drive or read-out of the X-ray detection sensor 102, and communicates with the control unit 104.

The detection unit 101 also includes a cable 107 configured to bear communication transmission and power supply to give and receive a control signal and an image signal between the electric circuit 106 and the control unit 104.

When an X-ray image is actually photographed, it is necessary to change a positional relation between the detection unit 101 and a subject according to a region to be photographed or a condition of the subject. Therefore, various stands are used to constantly maintain a state where the detection unit 101 is positioned to the subject.

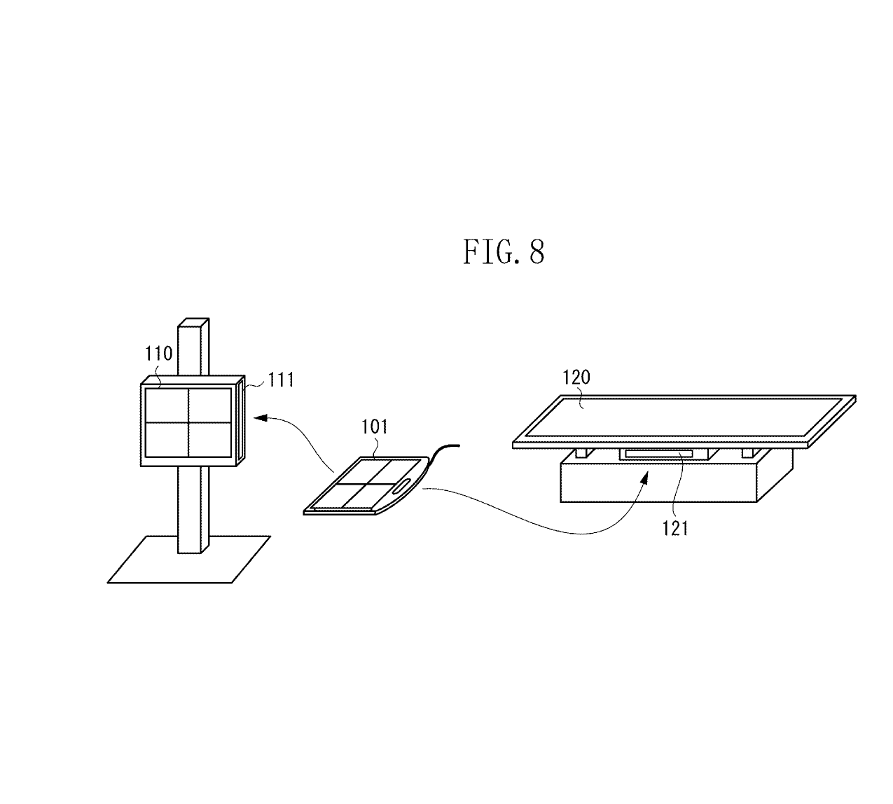

A typical stand is illustrated in FIG. 8. Examples thereof include a stand 110 used to photograph a chest portion in a standing position and a photographing table 120 used to photograph a chest portion or an abdominal portion in a recumbent position. Storage units 111 and 121 configured to hold the detection unit 101 are provided on these stands to correctly position the detection unit 101 to an X-ray tube vessel 103.

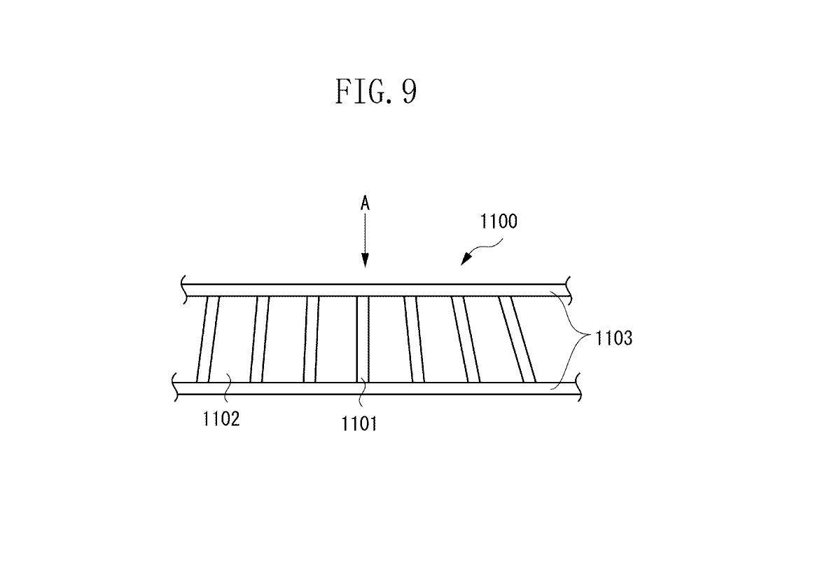

When scattered X rays are generated by the X rays radiated to the subject, the scattered X rays become noise components, which lower image quality. Therefore, a grid having a cross section structure illustrated in FIG. 9 is generally used to remove the scattered X rays. The grid includes a lead foil 1101 having low X-ray transmissivity, an intermediate material 1102, and a cover material 1103, to reduce the scatteration of the X rays. The intermediate material 1102 and the cover material 1103 are made of a material having high X-ray transmissivity.

The grid includes the lead foils 1101 and the intermediate materials 1102 arranged so as to converge in a direction of an arrow A illustrated in FIG. 9, which is an incident ray direction of the X rays radiated from a predetermined distance. In the structure, the influence of scattered rays is reduced by allowing only the linear X rays to transmit. It is necessary to position the grid in a state where the center of the grid is made to coincide with the incident X-ray axis. In addition, it is necessary to position the grid in a state where the center of the grid is made to coincide with the effective photographing area of the detection unit so as to be adjusted to the effective photographing area of the detection unit.

Because the center of the effective photographing area coincides with the center of the outer shape of the cassette in a conventional cassette, a unit is provided such that the outer shape is made to coincide with the photographing center of the stand.

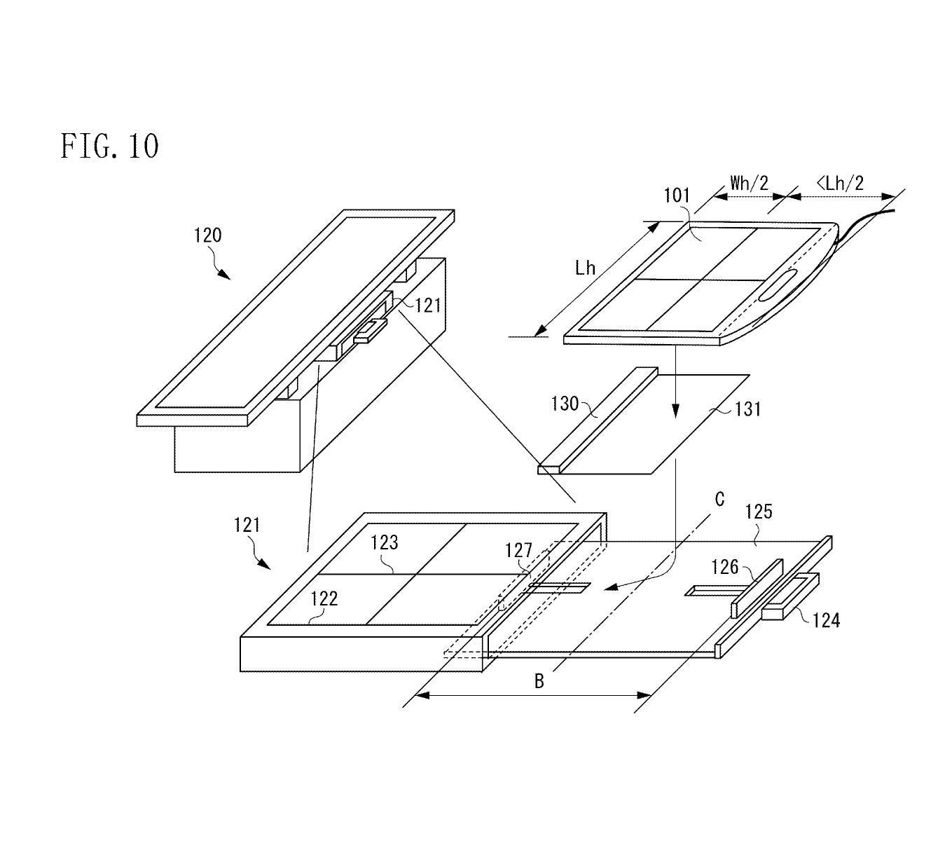

A storage unit 121 to which the detection unit 101 is attached is provided on the photographing table 120 illustrated in FIG. 10. A grid 122 is attached to the upper portion of the storage unit 121. A first detection unit and a second detection unit which have different shapes can be stored in the storage unit 121. A mark 123 representing a center position is formed on the surface of the grid 122. A drawing unit 125 configured to be drawn to the outside by a handle 124 is provided in the storage unit 121. Positioning members 126 and 127 configured to hold the detection unit 101 from both the sides to position the detection unit 101, are provided on the drawing unit 125. The positioning members 126 and 127 can be moved such that a width B becomes variable, centering on symbol C in FIG. 10. The width B is set to be equal to or greater than a long side size Lh of a half cut cassette used as a medical film size, as the movable range of the positioning member 126 and 127. This enables the detection unit 101 to be used by mounting in both vertical and horizontal directions, with the plane outer shape of a long side Lh×a short side Wh to the X-ray incidence plane of the half cut cassette.

Next, the detection unit 101 in the present exemplary embodiment will be described. The built-in X-ray detection sensor 102 includes a glass substrate on which a semiconductor layer is formed. The robustness of a housing is important as countermeasures against a risk such as static pressure or fall, which are required for portable photographing. In addition, because various electric substrates are mounted on the detection unit 101, an increase in weight thereof cannot be avoided as compared with a conventional film cassette.

Therefore, it is important to provide the handle from the viewpoint of operability in consideration of portability. Consequently, in the present exemplary embodiment, in consideration of the attaching property to the stand 120, a distance between the center of the photographing area and the outer shape of the handle is equal to or less than Lh/2 on the photographing area surface perpendicular to the X-ray incidence. The outer shape of a photographing unit is equal to or less than Lh×(Wh/2+Lh/2), and is greater by the addition of the handle (Lh−Wh)/2 than the film cassette. The shape can set the photographing unit in the movable range of the positioning member even if the center of the photographing area of the detection unit 101 is adjusted to the center of the grid 122. However, because the photographing unit has an asymmetric shape to the center of the photographing area of the detection unit 101, a position correction unit is required for the stand having the automatic aligning mechanism.

The position correction unit in the present exemplary embodiment will be described. In the present exemplary embodiment, a spacer member 130 having the same width dimension as that of the addition of the handle is set so as to be detachably attached on the drawing unit 125 of the storage unit 121. Thereby, the center of the photographing area of the detection unit 101 coincides with the center of the portion sandwiched between the positioning members 126 and 127. Because the drawing unit 125 is not generally moved up to a position where the back side positioning member 127 is generally exposed to the outside, an auxiliary unit grasped for handling is required when the spacer member 130 is attached to the storage unit 121. In the present exemplary embodiment, the spacer member 130 can be attached to the storage unit 121 without losing the attachment space of the detection unit 101 by attaching a thin sheet member 131 as illustrated in FIG. 10.

In the fourth exemplary embodiment, the spacer member is attached to the storage unit of the stand, and thereby the position correction unit is realized. In a fifth exemplary embodiment of the present invention, the equivalent purpose is attained by attaching the spacer member to the detection unit.

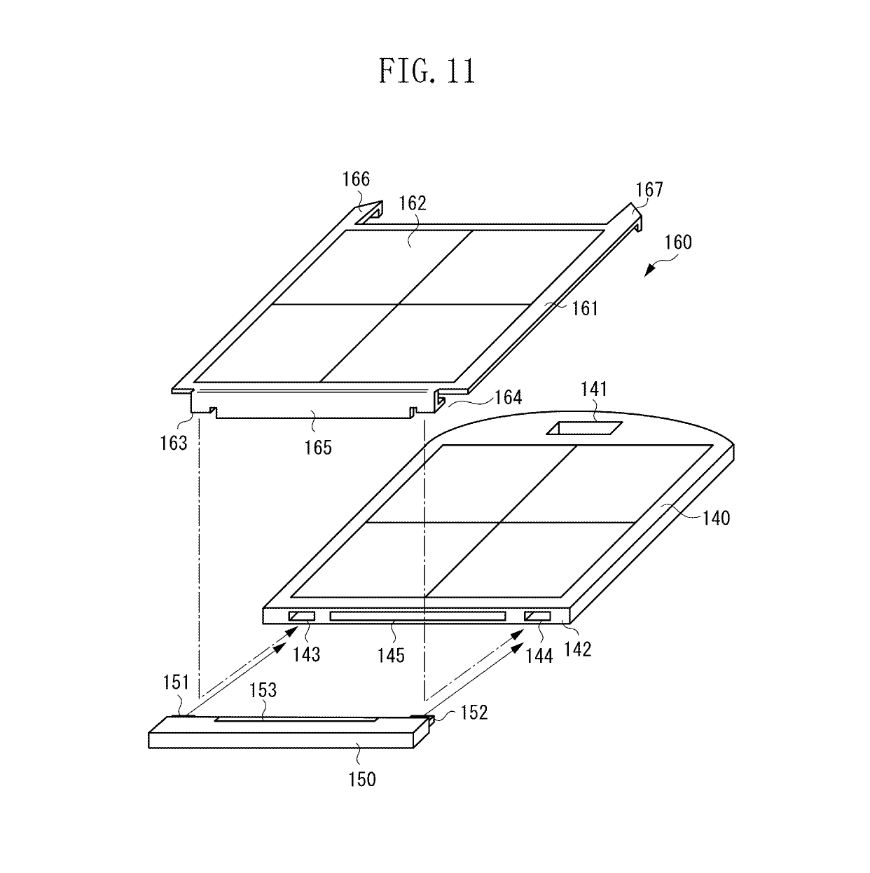

In a detection unit 140 illustrated in FIG. 11, a flat surface 142 is formed on a side of a housing facing a handle 141. Two recessed portions 143 and 144 are formed on the flat surface 142. A magnet 145 is embedded in a portion of the flat surface 142.

On the other hand, projections 151 and 152 are formed on a spacer member 150 so as to correspond to positions corresponding to the recessed portions 143 and 144 of the detection unit 140. A portion abutting on the magnet 145 is made of a magnetic metal 153. The spacer member 150 is attached by a magnetic force in a state where relative deviation is hardly generated by inserting the projections 151 and 152 into the recessed portions 143 and 144 of the detection unit 140. Even if the spacer member 150 is attached, the overall outer shape is set to be equal to or less than Lh×Lh. The spacer member 150 can be attached to the storage unit 121 as illustrated in the fourth exemplary embodiment.

The detection unit 140 may be used in a state where the detection unit 140 is attached to the stand, or may be independently used on a photographing table. In this case, the spacer member 150 is unnecessary, and the detection unit 140 is used in a state where the spacer member 150 is removed. Because a grid 122 incorporated in the stand cannot be used, a grid unit 160 can alternatively be attached to the outside of the housing of the detection unit 140. The grid unit 160 is obtained by fixing a grid 162 to a frame part 161. When the grid unit 160 is attached to the detection unit 140, attachment interfaces such as the recessed parts 143 and 144 and the magnet 145, which are used in attaching the spacer member 150 to the detection unit 140, are shared. Bending portions 163 and 164 are formed on one end of the frame part 161 so as to correspond to the recessed parts 143 and 144 of the detection unit 140. A plane portion 165 on which the magnet 145 abuts is formed. Bending portions 166 and 167 hooked to the detection unit are provided on the other end part.

In the fourth exemplary embodiment and the fifth exemplary embodiment, the spacer member is used. There are many cases to use the spacer member in combination with the existing cassette. When the spacer member is frequently replaced, the replacement work is troublesome. A sixth exemplary embodiment of the present invention eliminates this issue, and solves the problem without the need for attaching and detaching the spacer member.

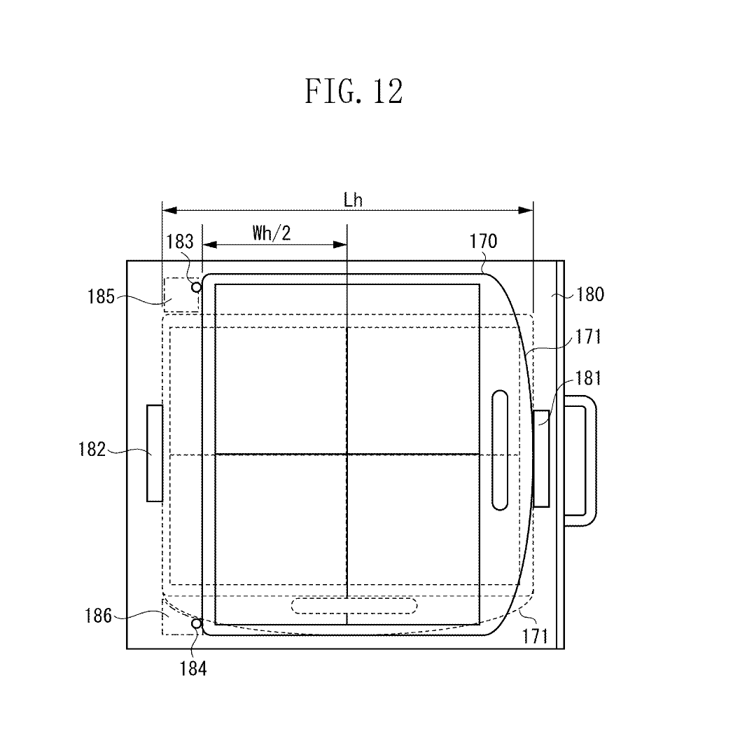

FIG. 12 is a view in which a detection unit 170 is overlapped with a state 171 where the detection unit 170 is rotated by 90 degrees to the center of an effective photographing area. An outer shape 171 of a handle of the detection unit 170 has a smaller width toward both end portions. In the area in FIG. 12, areas 185 and 186 are free from interference in the overlap state. When the detection unit 170 is attached to a drawing unit 180 provided in a storage unit, abutment portions 183 and 184 (stopper members) are formed on portions equivalent to the areas 185 and 186. In the state 171 where the detection unit 170 is horizontally set, the abutment parts 183 and 184 are attached in a state where the abutment portions 183 and 184 are sandwiched between both positioning members 181 and 182 without interfering with the detection unit 170. In a state where the detection unit 170 is vertically set, the center of the effective photographing area of the detection unit 170 is held in a state where the center is sandwiched between the abutment portions 183 and 184 and the positioning member 181, at a position where the center of the effective photographing area of the detection unit 170 is adjusted to the center of the apparatus, that is, the center line of the grid.

When a conventional cassette having an outer shape of Lh×Wh is attached to the drawing unit 180, the detection unit 170 can be used without any problems in both states where the center of the cassette coincides with the center of the grid when the detection unit 170 is horizontally set and vertically set.

As described above, the exemplary embodiments have been described by taking the half cut cassette having an outer shape size of Lh×Wh as an example. However, a stand having the other size such as a quarter cut size, for example, a pediatric stand, may be used. Even in such a case, the similar effect is obtained by generally replacing Lh×Wh with L×W.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2011-201865 filed Sep. 15, 2011 and No. 2011-248822 filed Nov. 14, 2011, which are hereby incorporated by reference herein in their entirety.

What is claimed is:

1. An X-ray imaging apparatus comprising:
a storage unit configured to store a portable X-ray imaging apparatus including an X-ray plane detection unit and a carrying handle unit; and
a positioning member configured to position a photographing center of the storage unit and a photographing center of the portable X-ray imaging apparatus by deviating a position of the portable X-ray imaging apparatus stored in the storage unit by an offset of the handle unit.

2. The X-ray imaging apparatus according to claim 1, wherein the handle unit is disposed on a long side of the portable X-ray imaging apparatus.

3. The X-ray imaging apparatus according to claim 1, wherein a part of the handle unit is configured to be stored in the portable X-ray imaging apparatus.

4. The X-ray imaging apparatus according to claim 1, wherein the positioning member is disposed on a side surface facing a side surface including the handle unit with the plane detection unit sandwiched between the positioning member and the handle unit.

5. The X-ray imaging apparatus according to claim 1, wherein the portable X-ray imaging apparatus includes an outlet opening of a cable on the side surface including the handle unit, and
wherein an offset by the outlet opening of the cable is smaller than that by the handle unit.

6. The X-ray imaging apparatus according to claim 1, wherein the storage unit has a width and a depth of a long side length of the portable X-ray imaging apparatus.

7. The X-ray imaging apparatus according to claim 1, wherein the storage unit is configured to store a first detection unit including a plane perpendicular to X-ray incidence, the plane having a long side with a length of L and a short side with a length of W, and a second detection unit including a plane perpendicular to X-ray incidence, the plane having a long side with a length of L and a short side with a length equal to or less than (W/2+L/2) and including a handle having a width equal to or less than (L−W)/2.

8. A storage apparatus for an X-ray imaging apparatus, the storage apparatus comprising:
a storage unit configured to store a portable X-ray imaging apparatus including an X-ray plane detection unit and a carrying handle unit;
a holding member configured to hold the portable X-ray imaging apparatus in the storage unit; and
an adjusting unit configured to adjust a position of the holding member by an offset of the handle unit.
